(19) United States
(12) Patent Application Publication
(10) Pub. No.: US 2006/0290830 A1
(43) Pub. Date: Dec. 28, 2006

(54) SEMI-TRANSMISSIVE LIQUID CRYSTAL DISPLAY DEVICE AND METHOD OF MANUFACTURE THEREOF

(75) Inventors: Hiroshi TERAMOTO, Tokyo (JP); Yoshimitsu Ishikawa, Tokyo (JP); Yasuhiro Morii, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: MITSUBISHI DENKI KABUSHIKI KAISHA, Chiyoda-ku (JP)

(21) Appl. No.: 11/421,233

(22) Filed: May 31, 2006

(30) Foreign Application Priority Data
Jun. 23, 2005 (JP) 2005-183216

(51) Int. Cl. G02F 1/1333; G02F 1/1335

(52) U.S. Cl. 349/56; 349/106; 349/113

(57) ABSTRACT

A semi-transmissive liquid crystal display device includes a TFT array substrate having a transmission pixel electrode that forms a transmission area and a reflection pixel electrode that forms a reflection area, a color filter substrate having a color filter formed by using a color material and a light-shielding film provided around the color filter, and a liquid crystal held between the TFT array substrate and the color filter substrate. The semi-transmissive liquid crystal display device further includes an opening provided in the color material in the reflection area and having at least two sides formed over the light-shielding film of finished dimensional accuracy higher than that of the color material, and a resin film formed to cover the color material while burying the opening.

### BACKGROUND OF THE INVENTION

1. Field of the Invention

This invention relates to semi-transmissive liquid crystal display devices and methods of manufacture thereof, and more particularly to semi-transmissive liquid crystal display devices in which a color material in a reflection area is provided with an opening and methods of manufacture thereof.

2. Description of the Background Art

In a typical semi-transmissive liquid crystal display device, a substrate on which a TFT (thin film transistors) is formed (hereafter also called a TFT array substrate) is provided with a transmission area transmitting backlight, and a reflection area reflecting external light that has entered a liquid crystal layer, for each pixel. In a position facing the TFT array substrate, there is provided a substrate on which a color filter using red, green and blue color materials is formed (hereafter also called a color filter substrate). The TFT array substrate and the color filter substrate hold a liquid crystal layer therebetween.

The semi-transmissive liquid crystal display device includes both the transmission area having high visibility in a dark place and low visibility in a bright place where external light is brighter than backlight, and the reflection area having high visibility in a bright place and low visibility in a dark place. The semi-transmissive liquid crystal display device therefore has good optical characteristics under intense external light as well as in a dark closed environment. On the TFT array substrate formed is a pixel electrode to be connected to the TFT. The pixel electrode is provided with a transmission electrode acting as the transmission area and a reflection electrode acting as the reflection area.

On the color filter substrate formed are a light-shielding film (hereafter also called a black matrix (BM)), a transparent resin layer, and a transparent electrode layer around the color filter using red, green and blue color materials. The black matrix is a metal film and the like for shielding light unnecessary for display in the transmission area and the reflection area. The transparent resin layer is an insulating film for covering unevenness resulting from a difference in thickness between the color materials, overlap between adjacent color materials, overlap between the black matrix and the color materials or the like, and easing the steps. The transparent electrode layer is a conductive film formed as an opposed electrode to the pixel electrode.

In the semi-transmissive liquid crystal display device, transmitted light in the transmission area passes through the color filter only once, whereas reflected light in the reflection area passes through the color filter twice upon entrance and exit. This causes a difference in optical concentration between the transmitted light in the transmission area and the reflected light in the reflection area, resulting in an insufficient quantity of the reflected light in the reflection area. To address this problem, conventional semi-transmissive liquid crystal display devices have employed a method of providing an opening and thus partially not providing a color material in a color filter in the reflection area, a method of changing transmittivity of a color material between the transmission area and the reflection area, and so on. The method of partially not providing a color material in a color filter in the reflection area is described in detail in Japanese Patent Application Laid-Open No. 2003-215560, for example.

Also in the semi-transmissive liquid crystal display device, the thickness of the liquid crystal layer (also called a gap between the TFT array substrate and the color filter substrate, or a cell gap) is changed between the transmission area and the reflection area in order to improve the luminance characteristics of the reflected light. More specifically, letting “dt” denote the thickness of the liquid crystal layer in the transmission area, the thickness of the liquid crystal layer in the reflection area is defined as “½ dt”. The thickness of the liquid crystal layer is changed by providing an organic film structure on the color filter substrate side or the TFT array substrate side. In the above method of partially not providing a color material in a color filter in the reflection area, an opening where the color material has been extracted (hereafter called a color material opening) is filled with the organic film to thereby prevent the thickness of the liquid crystal layer from changing in that portion.

In such ways, the semi-transmissive liquid crystal display device controls the optical characteristics of the reflected light by providing the color material opening in the reflection area. As the optical characteristics of the reflected light are controlled by the area of the color material opening, however, the dimensional accuracy of the color material opening has a direct influence upon the optical characteristics of the reflected light. A problem is thus encountered that variations in dimensional accuracy of the color material opening cause variations in optical characteristics of the reflected light.

Furthermore, considering a cross section of the portion where the color material opening is provided, the color material opening is filled with the organic film as described above. However, since the color material is relatively thick, it is difficult to fill the color material opening with the organic film completely smoothly, resulting in the occurrence of slight steps in that portion. A problem is thus encountered that such steps cause variations in reflectivity, which is one of the optical characteristics of the reflected light.

### SUMMARY OF THE INVENTION

It is an object of this invention to provide a semi-transmissive liquid crystal display device capable of reducing variations in optical characteristics of reflected light.

In an aspect of the invention, a semi-transmissive liquid crystal display device includes: a first substrate having a transmission pixel electrode that forms a transmission area, and a reflection pixel electrode that forms a reflection area; a second substrate having a color filter formed by using a color material, and a light-shielding film provided around the color filter; and a liquid crystal held between the first substrate and the second substrate. The semi-transmissive liquid crystal display device further includes: an opening provided in the color material in the reflection area, and having at least two sides formed over the light-shielding film of finished dimensional accuracy higher than that of the color material; and a resin film formed to cover the color material while burying the opening.

The semi-transmissive liquid crystal display device includes the opening having at least two sides formed over the light-shielding film of finished dimensional accuracy higher than that of the color material. This improves the dimensional accuracy of the opening, thereby reducing variations in optical characteristics of reflected light.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a plan view illustrating a TFT array substrate in a semi-transmissive liquid crystal display device according to a first preferred embodiment of this invention;

FIGS. 2A to 2E are cross-sectional views illustrating the TFT array substrate in the semi-transmissive liquid crystal display device according to the first preferred embodiment;

FIG. 3 is a plan view illustrating a color filter substrate in the semi-transmissive liquid crystal display device according to the first preferred embodiment;

FIGS. 4A to 4F are cross-sectional views illustrating the color filter substrate in the semi-transmissive liquid crystal display device according to the first preferred embodiment;

FIG. 5 is a plan view illustrating a color filter for one picture element in a semi-transmissive liquid crystal display device;

FIG. 6 is a plan view illustrating a color filter for one pixel according to the first preferred embodiment;

FIG. 7 illustrates area variations of a color material opening according to the first preferred embodiment;

FIG. 8 is a plan view illustrating a color filter for one picture element according to a second preferred embodiment of this invention;

FIG. 9 illustrates area variations of a color material opening according to the second preferred embodiment;

FIG. 10 is a plan view illustrating a color filter for one picture element according to a third preferred embodiment of this invention;

FIG. 11 illustrates area variations of a color material opening according to the third preferred embodiment;

FIG. 12 is a plan view illustrating a color filter for one picture element according to a fourth preferred embodiment of this invention;

FIG. 13 illustrates area variations of a color material opening according to the fourth preferred embodiment;

FIG. 14A is a plan view illustrating a color filter for one pixel according to a fifth preferred embodiment of this invention;

FIG. 14B illustrates a color material opening according to the fifth preferred embodiment;

FIG. 15 explains the relationship between the area of the color material opening and a step on a transparent resin layer according to the fifth preferred embodiment;

FIG. 16 explains the relationship between the thickness of a liquid crystal layer and the transmittivity of the liquid crystal;

FIG. 17A is a plan view illustrating another color filter for one pixel according to the fifth preferred embodiment;

FIG. 17B illustrates another color material opening according to the fifth preferred embodiment; and

FIG. 18 illustrates a color material opening in a semi-transmissive liquid crystal display device according to a sixth preferred embodiment of this invention.

### DESCRIPTION OF THE PREFERRED EMBODIMENTS

### First Preferred Embodiment

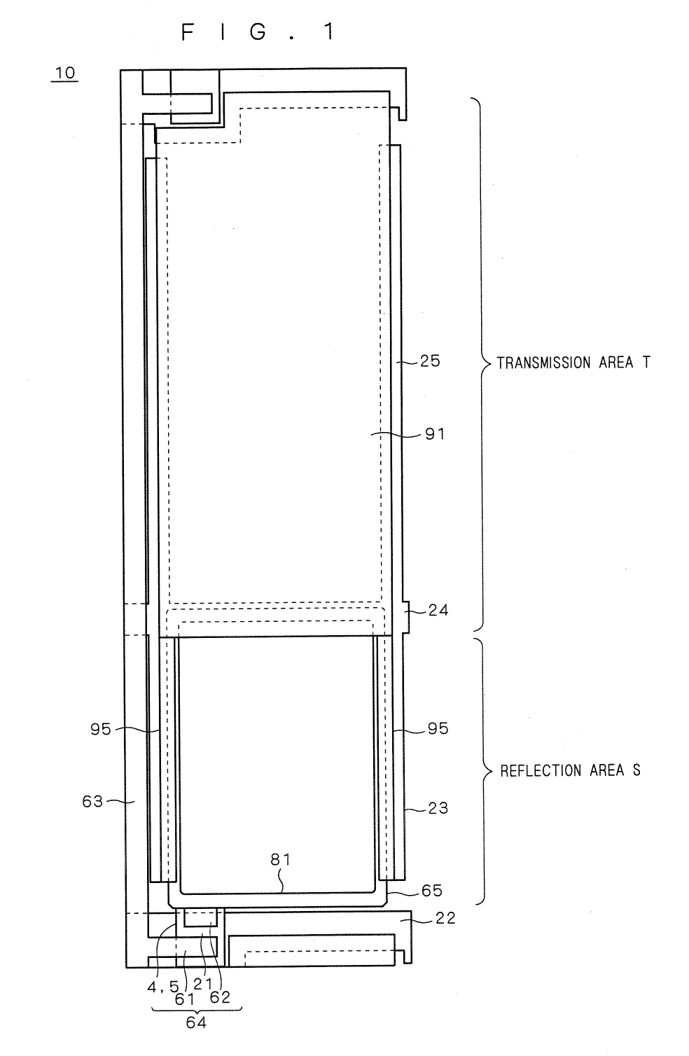

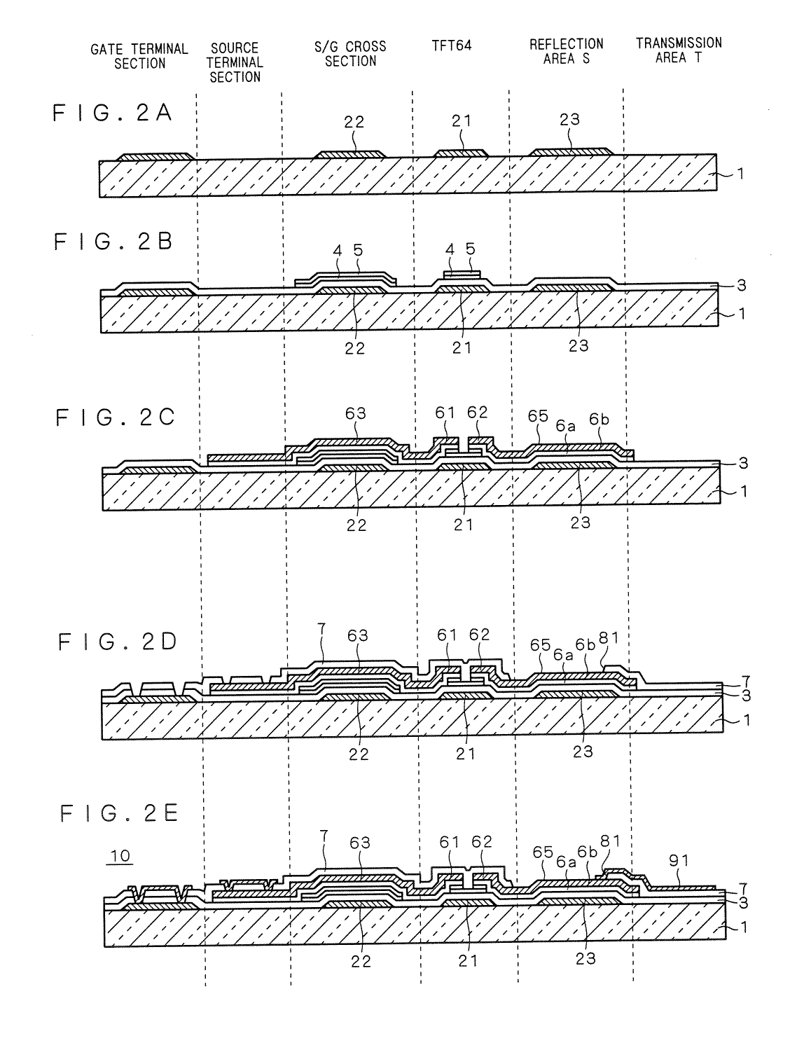

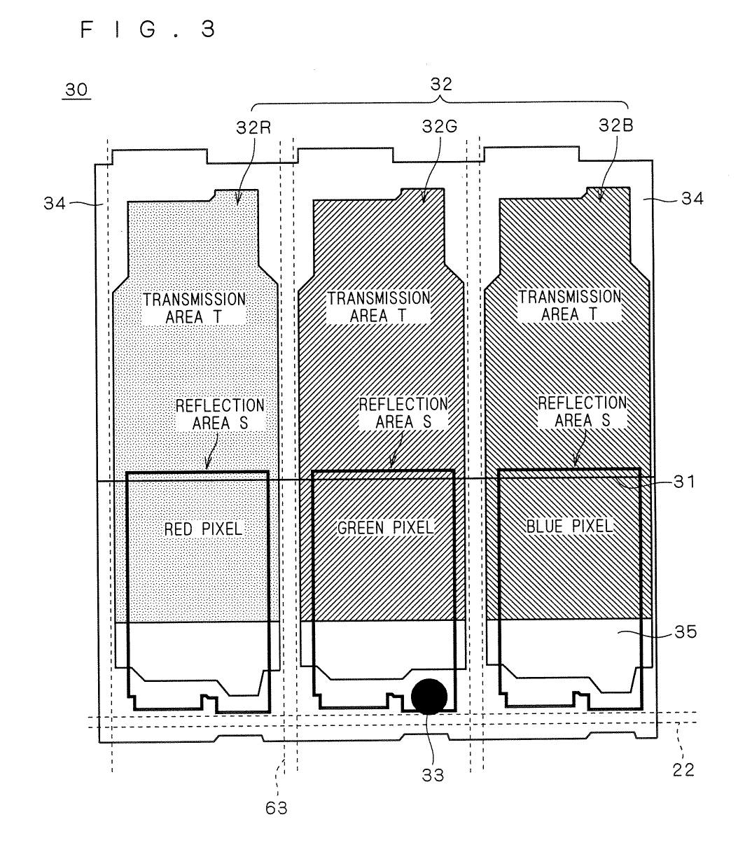

FIG. 1 is a plan view schematically illustrating a TFT array substrate 10 in a semi-transmissive liquid crystal display device according to a first preferred embodiment of this invention. In FIG. 1, a transmission area T transmitting light, and a reflection area S reflecting ambient light that has entered a liquid crystal layer are formed for each pixel provided on the TFT array substrate 10. FIGS. 2A to 2E are cross-sectional views explaining a method of manufacturing the TFT array substrate 10. In FIGS. 2A to 2E, cross sections of the transmission area T, the reflection area S, a TFT, an intersection of a source line and a gate line (S/G cross section), a source terminal section, and a gate terminal section are imaginarily illustrated as a single cross-sectional view.

In FIGS. 1 and 2A to 2E, on a transparent insulation substrate 1 such as a glass substrate formed are a gate line 22 including a gate electrode 21 made of a first conductive film, and a storage capacitance line 24 including a first storage capacitance electrode 23 provided in the reflection area S and a second storage capacitance electrode 25 provided in the transmission area T. The first and second storage capacitance electrodes 23 and 25, and the storage capacitance line 24 are provided for preventing light leakage from a backlight and maintaining a voltage over a fixed period of time.

A first insulating film 3 is provided over the gate line 22 and the like. A semiconductor active film 4 which is a semiconductor layer, and an ohmic contact film 5 are formed on the gate electrode 21 via the first insulating film (gate insulating film) 3. The ohmic contact film 5 has its central portion removed and is divided into two areas, one of which has a source electrode 61 made of a second conductive film laminated thereon, and the other has a drain electrode 62 made of the second conductive film laminated thereon. The semiconductor active film 4, the ohmic contact film 5, the gate electrode 21, the source electrode 61, and the drain electrode 62 form a TFT 64 acting as a switching element.

A reflection pixel electrode 65 extending from the drain electrode 62 is formed in the reflection area S. Namely, the reflection pixel electrode 65 is made of the second conductive film. Thus the second conductive film is made of a material having a metal film of high reflectivity in its surface layer. A source line 63 connected to the source electrode 61 is also made of the second conductive film.

A second insulating film 7 is provided to cover the reflection pixel electrode 65 and the like, and then part of the second insulating film 7 over the reflection pixel electrode 65 is removed to form a contact hole 81. A transmission pixel electrode 91 made of a conductive film of high transmittivity (hereafter also called a transparent conductive film) is formed over the second insulating film 7, to form the transmission area T. The transmission pixel electrode 91 is electrically connected to the reflection pixel electrode 65 via the contact hole 81, and further electrically connected to the drain electrode 62 via the reflection pixel electrode 65. A contrast-reduction-preventing electrode 95 is provided in a spacing between the reflection pixel electrode 65 and the source line 63 via the second insulating film 7. The contrast-reduction-preventing electrode 95 is a transparent conductive film, and is formed simultaneously with the transmission pixel electrode 91. The contrast-reduction-preventing electrode 95 is formed along and almost parallel to the source line 63.

Next, the method of manufacturing the TFT array substrate 10 in the semi-transmissive liquid crystal display device according to the first preferred embodiment will be described with reference to FIGS. 2A to 2E.

Firstly, the transparent insulation substrate 1 such as a glass substrate is washed to cleanse its surface. Then, as illustrated in FIG. 2A, the first conductive film is formed on the transparent insulation substrate 1 by sputtering and the like. The first conductive film is a thin film made of an alloy and the like having chromium (Cr), molybdenum (Mo), tantalum (Ta), titanium (Ti), aluminum (Al) or the like as the main component. In the first preferred embodiment, the first conductive film is made of a chromium film having a thickness of 400 nm, or an aluminum alloy film having a thickness of 250 nm.

Then, a first photolithography process is performed by patterning the first conductive film to form the gate electrode 21, the gate line 22, the first storage capacitance electrode 23, the storage capacitance line 24, and the second storage capacitance electrode 25. The first storage capacitance electrode 23 is formed almost on the whole surface of the reflection area S, while the second storage capacitance electrode 25 is formed partially in the transmission area T to become parallel to the source line 63. The storage capacitance line 24 is formed to be electrically connected to the first storage capacitance electrode 23, and along the source line 63. In the first photolithography process, firstly, the substrate is washed, then applied with a photosensitive resist, then dried, and then exposed using a mask of a prescribed pattern. Then in the first photolithography process, the exposed substrate is developed to thereby form a resist based on the mask pattern having been transferred onto the substrate. The resist is then hardened by the application of heat, and the first conductive film is subsequently etched to pattern the first conductive film. After patterning the first conductive film, the photosensitive resist is stripped off in the first photolithography process.

The first conductive film can be etched by wet etching with a known etchant. When the first conductive film is chromium, for example, a mixed solution of diammonium cerium nitrate and nitric acid is used. In addition, it is desirable that the first conductive film be etched by taper etching where a cross section of a pattern edge is rendered into a trapezoidal taper shape, in order to improve coverage of the insulating films in steps of the pattern edge to thereby prevent a short circuit with other lines.

Next, as illustrated in FIG. 2B, the first insulating film 3, the semiconductor active film 4, and the ohmic contact film 5 are successively formed by plasma CVD and the like. The first insulating film 3 acting as a gate insulating film is made of a single layer film that is one of a SiNx film, a SiOy film, and a SiOzNw film, or a multilayer film having those films laminated therein (the signs “x”, “y”, “z” and “w” are positive numbers indicative of stoichiometric compositions). When the first insulating film 3 is thin, a short circuit occurs easily at the intersection of the gate line 22 and the source line 63, and when the first insulating film 3 is thick, the ON current of the TFT 64 decreases to reduce the display characteristics. It is therefore desirable that the first insulating film 3 be formed as thin as possible while being thicker than the first conductive film. Also, the first insulating film 3 should be formed in several stages in order to prevent an interlayer short circuit due to the occurrence of a pin hole and the like. In the first preferred embodiment, the first insulating film 3 is made of a SiN film having a thickness of 400 nm by forming a SiN film having a thickness of 300 nm, and further forming a SiN film having a thickness of 100 nm.

The semiconductor active film 4 is made of an amorphous silicon (a-Si) film, a polysilicon (p-Si) film, and the like. When the semiconductor active film 4 is thin, the film disappears in the course of dry etching on the ohmic contact film 5 as described later, and when the semiconductor active film 4 is thick, the ON current of the TFT 64 decreases. The thickness of the semiconductor active film 4 is therefore determined in consideration of controllability of the amount of etching in the course of dry etching on the ohmic contact film 5, and a required value of the ON current of the TFT 64. In the first preferred embodiment, the semiconductor active film 4 is made of an a-Si film having a thickness of 150 nm.

The ohmic contact film 5 is made of an n-type a-Si film in which a-Si is doped with a small quantity of phosphorus (P), or an n-type p-Si film. In the first preferred embodiment, the ohmic contact film 5 is made of an n-type a-Si film having a thickness of 30 nm.

Subsequently, a second photolithography process is performed by patterning at least a portion where the TFT 64 is to be formed of the semiconductor active film 4 and the ohmic contact film 5. The breakdown voltage can be increased by leaving the semiconductor active film 4 and the ohmic contact film 5 not only in the portion where the TFT 64 is to be formed, but at the intersection of the gate line 22 and the source line 63 (S/G cross section) and in a portion where the source line 63 is to be formed. The semiconductor active film 4 and the ohmic contact film 5 can be etched by dry etching with a known gas composition (mixed gas of SF₆ and O₂ or mixed gas of CF₄ and O₂, for example).

Next, as illustrated in FIG. 2C, the second conductive film is formed by sputtering and the like. The second conductive film includes a first layer 6a made of an alloy including chromium, molybdenum, tantalum, titanium and the like, or having those elements as the main component, and a second layer 6b made of an alloy including aluminum and silver (Ag), or having those elements as the main component. The first layer 6a is formed on and in direct contact with the ohmic contact layer 5 and the first insulating film 3. The second layer 6b is formed thereon in direct contact with the first layer 6a. The second conductive film, which will be used as the source line 63 and the reflection pixel electrode 65, needs to be formed in consideration of wiring resistance and the reflection characteristics of its surface layer. In the first preferred embodiment, the first layer 6a of the second conductive film is made of a chromium film having a thickness of 100 nm, and the second layer 6b of an AlCu film having a thickness of 300 nm.

On the second conductive film, the contact hole 81 is to be formed by dry etching in a step as described later, followed by formation of a conductive thin film (transparent conductive film) partially in the contact hole 81 for establishing electrical connection. For this reason, the second conductive film should be made of a metal thin film resistant to surface oxidation, or a metal thin film having conductivity even after undergoing oxidation. When using an Al system material for the second conductive film, an Al nitride film, or a Cr, Mo, Ta, or Ti film should be formed on the surface in order to prevent conductivity deterioration resulting from surface oxidation.

Subsequently, a third photolithography process is performed by patterning the second conductive film to form the source line 63 including the source electrode 61, and the reflection pixel electrode 65 including the drain electrode 62. The drain electrode 62 and the reflection pixel electrode 65 are continuously formed of the same layer, and electrically connected to each other in the same layer. The second conductive film can be etched by wet etching with a known etchant.

Processing then continues with etching removal of the central portion of the ohmic contact film 5 of the TFT 64, to expose the semiconductor active film 4. The ohmic contact film 5 can be etched by dry etching with a known gas composition (mixed gas of SF₆ and O₂ or mixed gas of CF₄ and O₂, for example).

Moreover, a contact area (not shown) may be formed by removing the second layer 6b made of AlCu in a portion where the contact hole 81 as described later is to be formed. This contact area can be formed by performing exposure such as halftone exposure so that a photoresist thickness will be finished thin in the removed portion, reducing the resist with oxygen plasma and the like after dry etching the ohmic contact film 5 to thereby remove the resist only in the removed portion, and wet etching the AlCu, in the course of the third photolithography process. Consequently, the surface of the second conductive film in contact with the transmission pixel electrode 91 as described later becomes the chromium film of the first layer 6a, thus attaining a contact surface having good conductivity.

A halftone exposure process is described. Halftone exposure takes place through a halftone photomask (photomask having a pattern made of Cr with variable density, for example), so that the exposure intensity is adjusted to control a remaining thickness of a photoresist. Then, etching takes place on a film in a portion where the photoresist has been completely removed. Next, the photoresist is reduced with oxygen plasma and the like to thereby remove the photoresist only in a portion with a small remaining thickness. Lastly, etching takes place on the film in the portion with the small remaining thickness (where the photoresist has been removed). This allows two steps' worth of patterning by a single photolithography process.

When forming an Al nitride film (AlCuN, for example) and the like on the surface of the second conductive film, the reflectivity is slightly reduced but good contact is obtained with the transmission pixel electrode 91 as described later. Thus it is unnecessary to form a contact area (not shown), which eliminates the halftone exposure process.

Next, as illustrated in FIG. 2D, the second insulating film 7 is formed by plasma CVD and the like. The second insulating film 7 can be formed of the same material as the first insulating film 3, and its thickness should be determined in consideration of coverage of a lower layer pattern. In the first preferred embodiment, the second insulating film 7 is made of a SiN film having a thickness of 200 nm to 330 nm.

Then, still as illustrated in FIG. 2D, a fourth photolithography process is performed by patterning the second insulating film 7 to form the contact hole 81 over the reflection pixel electrode 65. The second insulating film 7 can be etched either by wet etching with a known etchant, or by dry etching with a known gas composition.

Then, as illustrated in FIG. 2E, a transparent conductive film to form the transmission pixel electrode 91 as described later is formed by sputtering and the like. The transparent conductive film may be made of ITO (indium-tin-oxide), SnO2 and the like, and should be made of ITO in particular in terms of chemical stability. While the ITO may be either crystallized ITO or amorphous ITO (a-ITO), the a-ITO needs to be crystallized by the application of heat to the crystallization temperature of 180° C. or more after patterning. In the first preferred embodiment, the transparent conductive film is made of a-ITO having a thickness of 80 nm.

Lastly, still as illustrated in FIG. 2E, a fifth photolithography process is performed by patterning the transparent conductive film to form the transmission pixel electrode 91 in the transmission area T. In consideration of deviations and the like in the course of patterning, the transmission pixel electrode 91 is formed to overlap the reflection pixel electrode 65 via the second insulating film 7 in a boundary portion between the reflection area S and the transmission area T. A sidewall portion of the contact hole 81 acting as a connection portion of the reflection pixel electrode 65 and the transmission pixel electrode 91 is covered with the transparent conductive film.

Next, the structure of a color filter substrate 30 in the semi-transmissive liquid crystal display device according to the first preferred embodiment will be described. FIG. 3 is a plan view illustrating the color filter substrate 30 for one picture element (a group of three pixels of a red pixel, a green pixel, and a blue pixel). Each of the pixels shown in FIG. 3 is divided into the transmission area T and the reflection area S, and a transparent resin layer 31 is arranged in the reflection area S in order to change the thickness of the liquid crystal layer between the transmission area T and the reflection area S. The transparent resin layer 31 may be arranged below or above a color material 32, and is arranged above the color material 32 in the first preferred embodiment. A red color material 32R, a green color material 32G, and a blue color material 32B are formed on the red pixel, the green pixel, and the blue pixel, respectively. A light-shielding film 34 is further provided to prevent light leakage from the gate line 22, the source line 63, and the like. The above elements will be described later in detail with respect to a method of manufacturing the color filter substrate 30.

The provision of the transparent resin layer 31 in the reflection area S leads to the occurrence of steps on the boundary with the transmission area T, causing disorder of an orientation state of liquid crystals near the boundary. A semi-transmissive liquid crystal display device has a contrast that differs greatly between reflection mode and transmission mode, which is typically 100 or more in transmission mode and about 50 at the highest in reflection mode. This is a difference in principle caused by the addition of surface reflection of the liquid crystal display device to luminance of black display, as the reflection mode utilizes external light for display. It is therefore required either to shield light by providing a light-shielding film (black matrix) in the portion where the orientation state of liquid crystals falls into disorder (step portion), or to arrange the step portion in the reflection area S. In the first preferred embodiment, the step portion is arranged in the reflection area S as illustrated in FIG. 3, so that the reflection area S should not be reduced. In consideration of misalignment between the TFT array substrate 10 and the color filter substrate 30, the forming position accuracy and deviations therefrom of the transparent resin layer 31, the forming position accuracy and deviations therefrom of the reflection pixel electrode 65 and so on, the distance from the step portion to the transmission area T is set to 8 μm in the first preferred embodiment.

Reflected light in the reflection area S, which passes through the color filter twice upon entrance and exit, becomes dark in hue and decreases in luminance by the square of the transmittivity of the color materials. For this reason, in the semi-transmissive liquid crystal display device according to the first preferred embodiment, a color material opening 35 is provided in the reflection area S of each pixel by partially extracting the color material. The reflected light is not colored in the color material opening 35 that has high transmittivity, so the reflected light in the whole of the reflection area S with the color material opening 35 becomes light in hue and increases in luminance. The color material opening 35 is filled with the transparent resin layer 31 and flattened so that unevenness that develops on the surface of the transparent resin layer 31 measures 0.4 μm or less.

In FIG. 3, a columnar spacer 33 is arranged near a position facing the gate line 22 on the color filter substrate 30. The columnar spacer 33 may alternatively be arranged near a position facing the source line 63 where the light-shielding film 34 is formed, or near a position facing the TFT 64. In FIG. 3, the positions facing the gate line 22 and the source line 63 are indicated by dashed lines.

The height of the columnar spacer 33 is optimized in accordance with the thickness of the liquid crystal layer in the reflection area S. The set optimum value depends on the materials on the opposed TFT array substrate 10 and the materials for a base film of the columnar spacer 33, and needs to be optimized for each device. Note that the thickness of the liquid crystal layer in the transmission area T cannot be significantly increased due to restrictions in terms of the response speed characteristics. On the other hand, when the thickness of the liquid crystal layer in the reflection area S is increased too much, white display at the time of reflection will be tinged with too much yellow. Further, as described above, the thickness of the liquid crystal layer in the reflection area S needs to be set to about half the thickness of the liquid crystal layer in the transmission area T. In consideration of these facts, the thickness of the liquid crystal layer in the reflection area S needs to be set to about 1 to 3 μM. In the first preferred embodiment, the thickness of the liquid crystal layer in the reflection area S is set to 2 μm, and the height of the columnar spacer 33 is set to 2.2 μm. The thickness of the liquid crystal layer in the transmission area T is set to 3.8 μm.

The color materials 32 in the semi-transmissive liquid crystal display device according to this invention are arranged in a stripe pattern or a dot pattern. Adjacent color materials 32 are arranged while overlapping each other, or with a certain interval therebetween. The color material 32 has a thickness of about 0.5 to 3.5 μm, which depends on the desired color characteristics. The color material 32 in the first preferred embodiment has a thickness of 1.2 μm to attain a color reproduction range (Gamut) of 50%. This thickness is the same for red, blue and green, in order to prevent a change in color caused by a difference in thickness of the liquid crystal layer in the reflection area S. Further in the first preferred embodiment, the color materials 32 have a stripe shape and are adjacently arranged with an interval of 5 μm in consideration of the positional accuracy and variations in shape of the color materials 32, as adjacent color materials 32 having the same thickness can cause, when being superimposed, a short circuit with the opposed TFT array substrate 10.

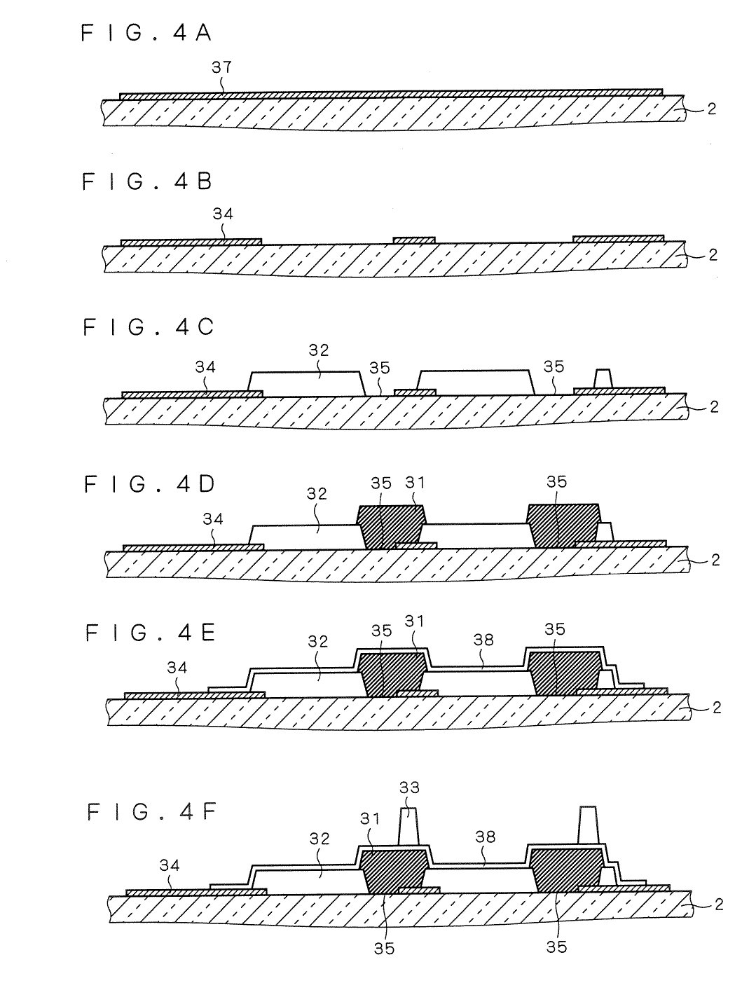

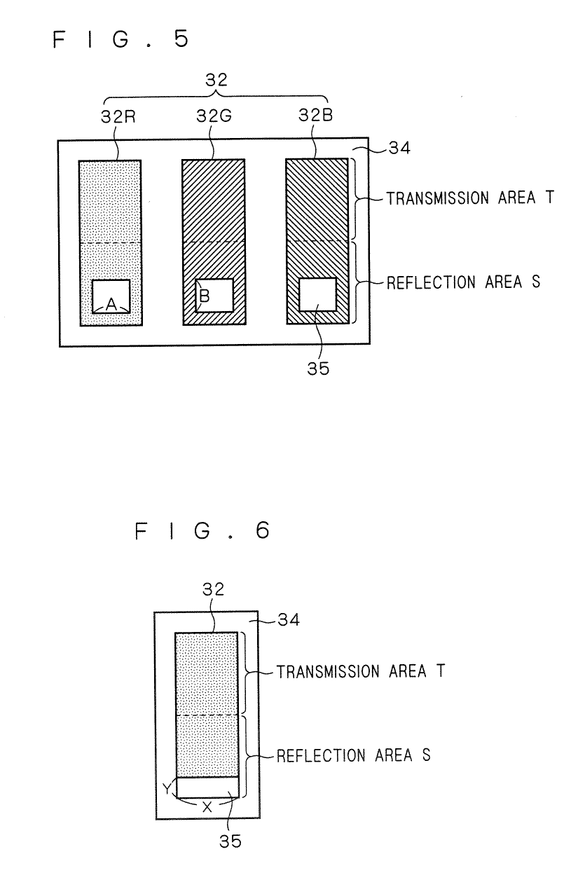

Next, a method of manufacturing the color filter substrate 30 in the semi-transmissive liquid crystal display device according to the first preferred embodiment will be described with reference to FIGS. 4A to 4F.

Firstly, a transparent insulation substrate 2 such as a glass substrate is washed to cleanse its surface. After the wash, as illustrated in FIG. 4A, a film 37 having light-shielding properties is formed on the transparent insulation substrate 2 by sputtering, spin coating, and the like. The film 37 having light-shielding properties is then patterned to form a light-shielding film 34, as illustrated in FIG. 4B. More specifically, the film 37 having light-shielding properties is applied with a photosensitive resist, and then exposed and developed by photolithography, to thereby form the pattern of the light-shielding film 34. The film 37 having light-shielding properties may be of multilayer structure including a Cr oxide film, a Ni oxide film and the like, which blacken the transparent insulation substrate 2 when viewed from outside. In the first preferred embodiment, the film 37 is made of a multilayer film of Cr oxide having a thickness of 150 nm.

Next, as illustrated in FIG. 4C, the color material 32 is applied to the transparent insulation substrate 2 on which the light-shielding film 34 has been formed. The color material 32 may be applied in any given order, which is applied, although not shown, in the order of the red color material 32R, then the green color material 32G, and then the blue color material 32B in the first preferred embodiment. The application of the red color material 32R is described in detail, whose application steps will be repeated for each of the color materials 32. First, the red color material 32R is applied to the whole surface of the substrate by spin coating and the like, and controlled to have a thickness of 1.2 μm as described above. Then, exposure and development are performed by photolithography to form the red color material 32R of a prescribed pattern. Further, the color material opening 35 is formed partially in the color material 32 in the reflection area S in the course of the above patterning by photolithography.

Then, as illustrated in FIG. 4D, the transparent resin layer 31 is formed only in the reflection area S in order to adjust the thickness of the liquid crystal layer between the reflection area S and the transmission area T. The transparent resin layer 31 is applied to the transparent insulation substrate 2 in a desired thickness by spin coating and the like, then exposed, and then developed to be completed. The thickness of the transparent resin layer 31 is set in such a manner that a difference in thickness of the liquid crystal layer between the transmission area T and the reflection area S is 2.0 μm. In the course of forming the transparent resin layer 31, the color material opening 35 is filled with the transparent resin layer 31.

Next, as illustrated in FIG. 4E, a transparent electrode 38 is formed on the color material 32, the transparent resin layer 31, and the like. More specifically, the transparent electrode 38 which is an ITO film is formed on the color material 32, the transparent resin layer 31, and the like by mask sputtering, evaporation, and the like. In the first preferred embodiment, the transparent electrode 38 is formed by mask sputtering, and has a thickness of 1450 angstroms (0.145 μm).

Lastly, as illustrated in FIG. 4F, the columnar spacer 33 is formed on the transparent resin layer 31 via the transparent electrode 38. A typical process for this is that a transparent resin film is applied by slit & spin and the like, and then the pattern of the columnar spacer 33 is formed by photolithography. Since the columnar spacer 33 needs to be applied uniformly and hard, NN 780 of JSR Corporation, with its thickness being set to 2.2 μm, is used in the first preferred embodiment.

Although not shown, the TFT array substrate 10 and the color filter substrate 30 thus formed are applied with orientation films in a subsequent cell step, and subjected to a rubbing process in a fixed direction. A sealing material for bonding those substrates is then applied to one of the substrates. At the same time the sealing material is applied, a transfer electrode for electrically connecting those substrates is arranged as well. The TFT array substrate 10 and the color filter substrate 30 are superimposed so that their respective orientation films face each other, aligned, and then bonded to each other by hardening the sealing material.

The sealing material is made of thermosetting epoxy system resin, photo-setting acrylic system resin, and the like. MP-3900 of Nippon Kayaku Co., Ltd., a sealing material made of thermosetting epoxy system resin, is used in the first preferred embodiment. The transfer electrode is made of silver paste, conductive particles present in the sealing material, and the like. Micropearl® (diameter: 5 μm) with Au coating of Sekisui Chemical Co., Ltd. is used for the transfer electrode in the first preferred embodiment. After bonding the TFT array substrate 10 and the color filter substrate 30, a liquid crystal is injected between the substrates. A polarizing plate is bonded on both sides of the liquid crystal panel thus formed, and then a backlight unit is attached to the rear surface, thereby completing the semi-transmissive liquid crystal display device.

Moreover, the plurality of gate lines 22 and the plurality of source lines 63 are formed on the liquid crystal panel, with the TFTs 64 being formed at the respective intersections of the gate lines 22 and the source lines 63. The TFT 64 has a gate connected to the gate line 22 via the gate electrode 21, a source connected to the source line 63 via the source electrode 61, and a drain connected to a pixel electrode (the reflection pixel electrode 65 and the transmission pixel electrode 91) via the drain electrode 62, respectively. Also on the liquid crystal panel, pixels formed by the TFTs 64 and the pixel electrodes (the reflection pixel electrodes 65 and the transmission pixel electrodes 91) are arranged in a matrix. Since the pixels are arranged in a matrix, a pixel displaying red, a pixel displaying green, and a pixel displaying blue are repeatedly connected to a single gate line 22.

In this liquid crystal panel, the TFT 64 connected to the gate line 22 having been selected enters an ON state, and an image signal supplied to the source line 61 is applied to the pixel electrode to thereby display a desired image. The orientation of liquid crystal molecules is controlled by the voltage applied to the pixel electrode, so the transmittivity of light passing through the liquid crystal layer can be controlled. The source line 63 has one side connected to the TFT 64, and the other side to the source terminal section outside a display area. The source terminal section is connected to a terminal of a tape carrier package via an anisotropic conductive sheet and the like, to be connected to a source driver mounted on the tape carrier package.

The gate line 22 has one side connected to the TFT 64, and the other side to the gate terminal section outside the display area. The gate terminal section is connected to a terminal of the tape carrier package via an anisotropic conductive sheet and the like, to be connected to a gate driver mounted on the tape carrier package.

The color filter substrate 30 has the transparent electrode 38 as an opposed electrode causing an electric field with the pixel electrode provided on the TFT array substrate 10, the orientation film for orientating the liquid crystal, the color material 32, the light-shielding film 43, and the like formed thereon. The color filters that are formed using the color materials 32 are provided correspondingly to the pixels. For example, the red color materials 32 are provided correspondingly to the pixels supplied with a red image signal on the TFT array substrate 10. The green and blue color materials 32 are provided in much the same way. As the pixels supplied with a red image signal are provided along the source line 63, the red color materials 32 are formed in a dot pattern or a stripe pattern along the source line 63 as well. The green and blue color materials 32 are provided in much the same way.

The TFT array substrate 10 and the color filter substrate 30 hold a liquid crystal therebetween. The source electrode 61 on the TFT array substrate 10 is connected to metal films such as ITO forming the transmission pixel electrode 91 and Al forming the reflection pixel electrode 65. The reflection pixel electrode 65 may be formed above an organic film or an inorganic film, or below an inorganic film, acting as a pixel electrode and a reflection material. An area where this reflection pixel electrode 65 is formed becomes the reflection area S. And an area where the transmission pixel electrode 91 is formed becomes the transmission area T. In addition, the storage capacitance line 24 forming storage capacitance and the like are formed between the metal layer connected to the source electrode 61 and the transparent insulation substrate 1.

In the transmission area T, light from the backlight provided on the rear surface of the TFT array substrate 10 is colored via the color material 32 of the color filter, to exit from the display surface. In the reflection area S, on the other hand, external light passes through the color material 32 of the color filter to enter the liquid crystal panel, is reflected by the reflection pixel electrode 65, and again passes through the color material 32 of the color filter, to exit from the liquid crystal panel. In the first preferred embodiment, the color material opening 35 is provided partially in the color material 32 in the reflection area S. The color material opening 35 is filled with the transparent resin layer 31, so the steps on the surface of the transparent resin layer 31 caused by the presence or absence of the color material opening 35 measures 0.4 μm or less. The transparent resin layer 31 may be formed in a stripe pattern to cover the adjacent pixels, or in a dot pattern for each pixel.

As recited in the Background Art section, the optical characteristics of the reflected light can be controlled by providing the color material opening 35. Namely, the optical characteristics of the reflected light can be controlled by the ratio of the area of the color material 32 to the area of the color material opening 35 in the reflection area S. It is therefore important to accurately form the area of the color material opening 35.

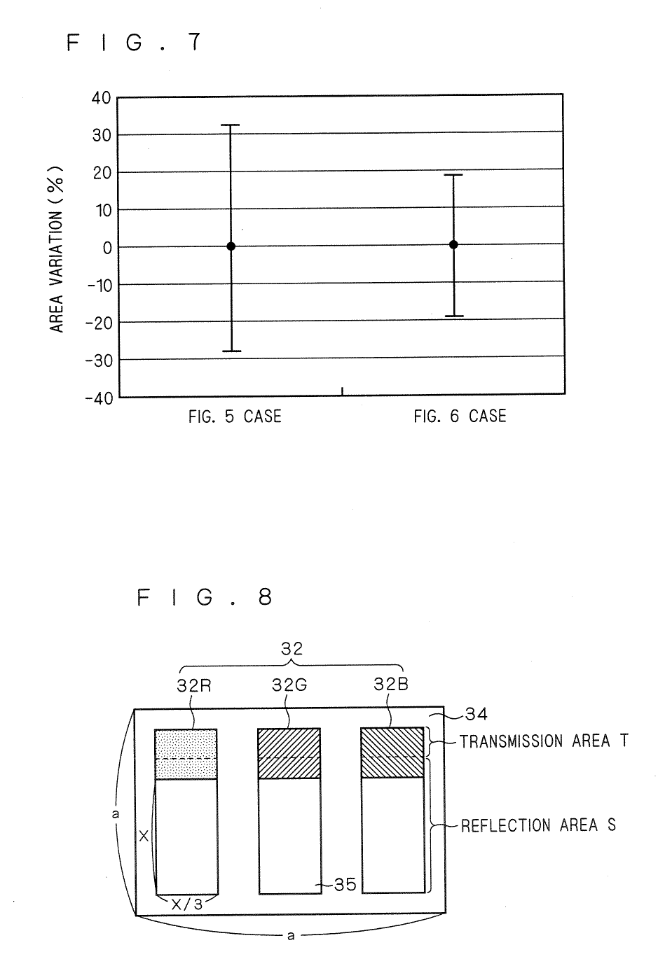

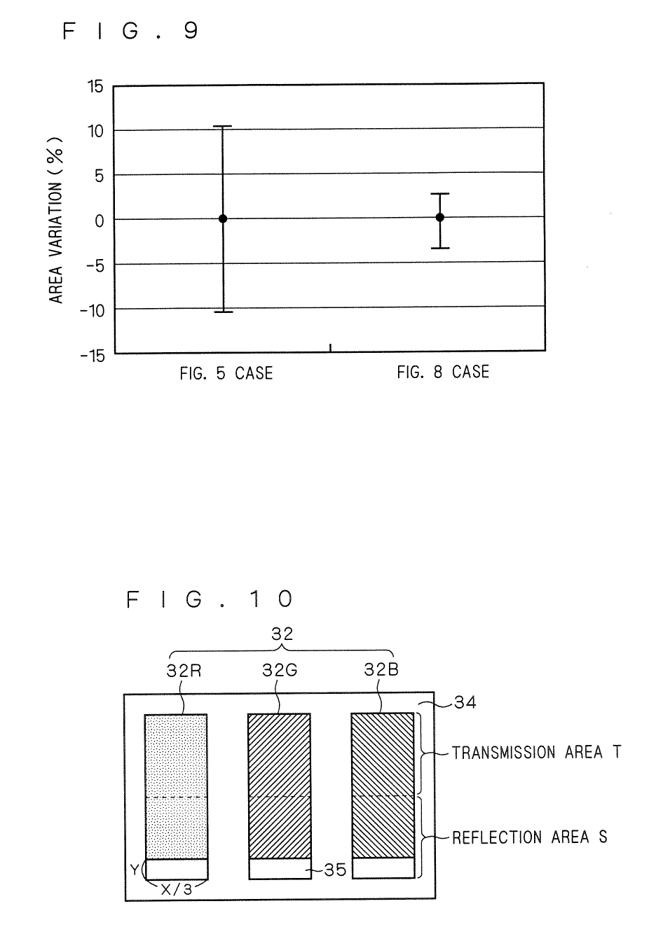

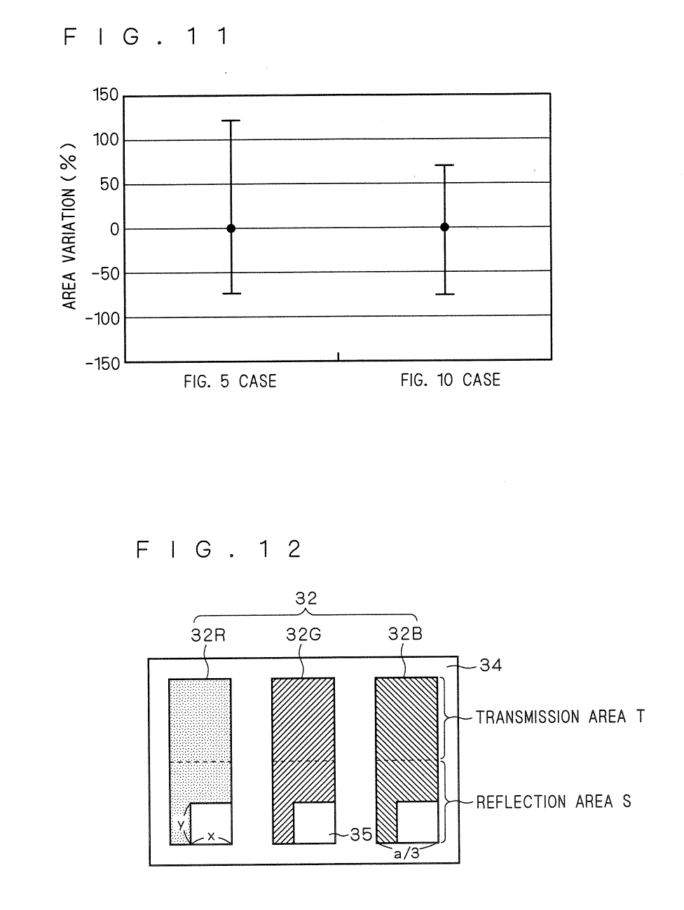

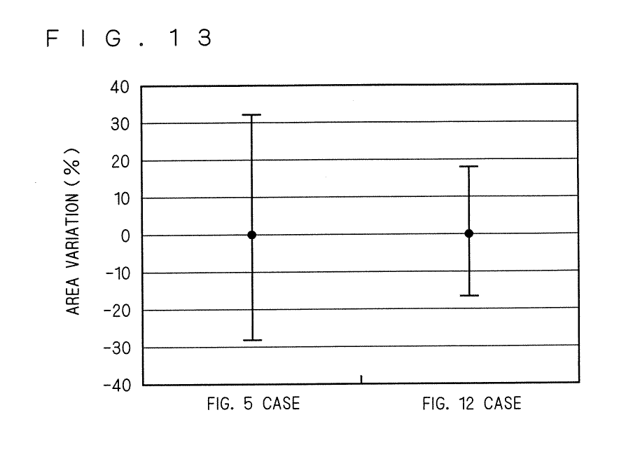

In the conventional semi-transmissive liquid crystal display devices, a color filter for one picture element is formed as depicted in FIG. 5. In FIG. 5, the color material 32 is arranged in the order of the red color material 32R, the green color material 32G, and the blue color material 32B from left to right, with the light-shielding film 34 being formed around the color material 32. Each of the color materials 32 is divided into the transmission area T and the reflection area S, and the color material opening 35 is provided in the reflection area S. The color material opening 35 depicted in FIG. 5 is in contact with the color material 32 in all sides. The color material 32, which is typically made of a mixed material of an organic resist and ink such as a pigment, is processed with lower dimensional accuracy than a metal film processed by photolithography. Thus, when forming the color material openings 35 in contact with the color material 32 in all sides, the color material openings 35 vary in area from pixel to pixel.

Therefore, in the semi-transmissive liquid crystal display device according to the first preferred embodiment, three sides of the color material opening 35 are formed by the light-shielding film 34. Namely, as depicted in FIG. 6, the color material opening 35 having three sides surrounded by the light-shielding film 34 and the remaining one side surrounded by the color material 32 is formed in the reflection area S. The area of the color material opening 35 is set to attain desired reflectivity. When the color material 32 has a stripe pattern, the color material opening 35 may be formed in such a shape as to separate the stripe, or when the color material 32 has a dot pattern, the color material opening 35 may be formed in such a shape as to cut out part of the dot.

Letting X denote the horizontal length of the color material opening 35 shown in FIG. 6 and Y the vertical length, the ratio of the side in contact with the color material 32 to the perimeter of the color material opening 35 is expressed by the equation, X/(2X+2Y)=1/2(1+Y/X)<1/2 (where Y/X is always a positive value). In short, the ratio of the side in contact with the color material 32 to the perimeter of the color material opening 35 is less than 50%. Stated another way, the color material opening 35 according to the first preferred embodiment is formed in such a manner that the sum of the lengths of the sides in contact with the light-shielding film 34 is longer than the sum of the length of the side in contact with the color material 32.

With respect to the color material opening 35 shown in FIG. 5 that is surrounded by the color material 32 in four sides (where A denotes the horizontal length and B the vertical length), the area thereof is determined by (A±double dimensional accuracy of the color material 32)×(B±double dimensional accuracy of the color material 32). On the other hand, the area of the color material opening 35 according to the first preferred embodiment is determined by (X±double dimensional accuracy of the light-shielding film 34)×(Y±dimensional accuracy of the color material 32±dimensional accuracy of the light-shielding film 34). Note that the dimensional accuracy of the color material 32 is lower than that of the light-shielding film 34 which is typically a metal film processed by photolithography. More specifically, the dimensional accuracy of the color material 32 is about 3 μm, whereas the dimensional accuracy of the light-shielding film 34, when made of chromium which is a metal film, is increased to about 0.5 μm. Accordingly, the area of the color material opening 35 according to the first preferred embodiment can be finished more accurately than the area of the color material opening 35 shown in FIG. 5, reducing variations from pixel to pixel.

To give specific examples, when setting a desired area of the color material opening 35 to 1600 μm², the color material opening 35 shown in FIG. 5 has a horizontal length of A=40 μm and a vertical length of B=40 μm, while the color material opening 35 according to the first preferred embodiment has a horizontal length of X=80 μm and a vertical length of Y=20 μm. The ratio of the side in contact with the color material 32 to the perimeter of the color material opening 35 according to the first preferred embodiment is 40%.

In this case, with the dimensional accuracy of the color material 32 being 3 μm, the area of the color material opening 35 shown in FIG. 5 varies over a range from (40−6)×(40−6)=1156 μm² to (40+6)×(40+6)=2116 μm². Meanwhile, with the dimensional accuracy of the light-shielding film 34 made of chromium being 0.5 μm, the area of the color material opening 35 according to the first preferred embodiment varies over a range from (80−1)×(20−0.5−3)=1303.5 μm² to (80+1)×(20+0.5+3)=1903.5 μm .

That is, by changing the color material opening 35 shown in FIG. 5 to the color material opening 35 according to the first preferred embodiment, the variation with reference to the desired area from about +32.3% to about −27.8% can be improved to from about +19.0% to about −18.5%. FIG. 7 illustrates the area variation of the color material opening 35 shown in FIG. 5, and the area variation of the color material opening 35 shown in FIG. 6 according to the first preferred embodiment.

As described above, the liquid crystal display device according to the first preferred embodiment includes the color material opening 35 provided in the color material 32 in the reflection area S, and having the sum of the lengths of the sides in contact with the light-shielding film 34 longer than the sum of the length of the side in contact with the color material 32. This improves the area variation of the color material opening 35, thereby reducing variations in optical characteristics of reflected light.

While the light-shielding film 34 is made of chromium which is a metal film in the semi-transmissive liquid crystal display device according to the first preferred embodiment, the scope of this invention is not delimited by this. As long as it is of higher dimensional accuracy than the color material 32, the light-shielding film 34 may be made of black resin and the like.

### Second Preferred Embodiment

A semi-transmissive liquid crystal display device according to a second preferred embodiment of this invention has the same structure as the first preferred embodiment, except the color material opening 35 formed over the color filter substrate 30. Thus, the color material opening 35 will be described below and descriptions of the other elements are omitted.

FIG. 8 depicts the structure of a color filter for one picture element with reflection priority in the semi-transmissive liquid crystal display device according to the second preferred embodiment. In FIG. 8, the color material 32 is arranged in the order of the red color material 32R, the green color material 32G, and the blue color material 32B from left to right, with the light-shielding film 34 being formed around the color material 32. Each of the color materials 32 is divided into the transmission area T and the reflection area S, and the color material opening 35 is provided in the reflection area S.

As depicted in FIG. 8, again in the semi-transmissive liquid crystal display device according to the second preferred embodiment, three sides of the color material opening 35 are formed by the light-shielding film 34. Namely, the color material opening 35 having three sides surrounded by the light-shielding film 34 and the remaining one side surrounded by the color material 32 is formed in the reflection area S. The area of the color material opening 35 is set to attain desired reflectivity. When the color material 32 has a stripe pattern, the color material opening 35 may be formed in such a shape as to separate the stripe, or when the color material 32 has a dot pattern, the color material opening 35 may be formed in such a shape as to cut out part of the dot.

In FIG. 8, “a” denotes the horizontal length and the vertical length of one picture element, X/3 denotes the horizontal length of the color material opening 35, and X (X<a) denotes the vertical length of the color material opening 35. In this case, the ratio of the side in contact with the color material 32 to the perimeter of the color material opening 35 is expressed by the equation, (X/3)/(2X+2X/3)=1/8. In short, the ratio of the side in contact with the color material 32 to the perimeter of the color material opening 35 is 12.5%. Stated another way, the color material opening 35 according to the second preferred embodiment is formed in such a manner that the sum of the lengths of the sides in contact with the light-shielding film 34 is eight times as long as the sum of the length of the side in contact with the color material 32.

With respect to the color material opening 35 shown in FIG. 5 that is surrounded by the color material 32 in four sides (where A denotes the horizontal length and B the vertical length), the area thereof is determined by (A±double dimensional accuracy of the color material 32)×(B±double dimensional accuracy of the color material 32). On the other hand, the area of the color material opening 35 according to the second preferred embodiment is determined by ((X/3)±double dimensional accuracy of the light-shielding film 34)×(X±dimensional accuracy of the color material 32±dimensional accuracy of the light-shielding film 34). Note that the dimensional accuracy of the color material 32 is lower than that of the light-shielding film 34 which is typically a metal film processed by photolithography. Accordingly, the area of the color material opening 35 according to the second preferred embodiment can be finished more accurately than the area of the color material opening 35 shown in FIG. 5.

To give specific examples, when setting a desired area of the color material opening 35 to 19200 μm², the color material opening 35 shown in FIG. 5 has a horizontal length of A=75 μm and a vertical length of B=256 μm, while the color material opening 35 according to the second preferred embodiment has a horizontal length of X/3=80 μm and a vertical length of X=240 μm. The ratio of the side in contact with the color material 32 to the perimeter of the color material opening 35 according to the second preferred embodiment is 12.5%.

In this case, with the dimensional accuracy of the color material 32 being 3 μm, the area of the color material opening 35 shown in FIG. 5 varies over a range from (75−6)×(256−6)=17250 μm² to (75+6)×(256+6)=21222 μm². Meanwhile, with the dimensional accuracy of the light-shielding film 34 made of chromium being 0.5 μm, the area of the color material opening 35 according to the second preferred embodiment varies over a range from (80−1)×(240−0.5−3)=18685 μm² to (80+1)×(240+0.5+3)=19722 μm².

That is, by changing the color material opening 35 shown in FIG. 5 to the color material opening 35 according to the second preferred embodiment, the variation with reference to the desired area from about +10.5% to about −10.2% can be improved to from about +2.7% to about −3.3%. FIG. 9 illustrates the area variation of the color material opening 35 shown in FIG. 5, and the area variation of the color material opening 35 shown in FIG. 8 according to the second preferred embodiment.

As described above, in the liquid crystal display device according to the second preferred embodiment, the sum of the length of the side in contact with the color material 32 in the color material opening 35 amounts to 12.5% to the perimeter of the color material opening 35. This improves the area variation of the color material opening 35, thereby reducing variations in optical characteristics of reflected light.

### Third Preferred Embodiment

A semi-transmissive liquid crystal display device according to a third preferred embodiment of this invention has the same structure as the first preferred embodiment, except the color material opening 35 formed over the color filter substrate 30. Thus, the color material opening 35 will be described below and descriptions of the other elements are omitted.

FIG. 10 depicts the structure of a color filter for one picture element in the semi-transmissive liquid crystal display device according to the third preferred embodiment. In FIG. 10, the color material 32 is arranged in the order of the red color material 32R, the green color material 32G, and the blue color material 32B from left to right, with the light-shielding film 34 being formed around the color material 32. Each of the color materials 32 is divided into the transmission area T and the reflection area S, and the color material opening 35 is provided in the reflection area S.

The area of the color material opening 35 is set to 20 μm□ (400 μm²) or less, which is incapable of being formed by an opening in contact with the color material 32 in four sides.

In FIG. 10, X/3 denotes the horizontal length of the color material opening 35, and Y (when Y is extremely short with reference to (X/3)) denotes the vertical length of the color material opening 35. In this case, the ratio of the side in contact with the color material 32 to the perimeter of the color material opening 35 is expressed by the equation, (X/3)=1/2((3Y/X)+1). Y<<X/3 leads to 3Y/X<<1,whereby 1/2((3Y/X)+1) is approximated to 1/2.

To give specific examples, when setting a desired area of the color material opening 35 to 400 μm², the color material opening 35 shown in FIG. 5 has a horizontal length of A=20 μm and a vertical length of B=20 μm, while the color material opening 35 according to the third preferred embodiment has a horizontal length of X/3=80 μm and a vertical length of Y=5 μm. The ratio of the side in contact with the color material 32 to the perimeter of the color material opening 35 according to the third preferred embodiment is 47.1%, which is almost 50%.

The dimensional accuracy of this color material 32 with the minute opening is lower than those in the first and second preferred embodiments, to become 4 μm to 5 μm. In this case, with the finished dimensional accuracy of the color material 32 being 4.5 μm, the area of the color material opening 35 shown in FIG. 5 varies over a range from (20−2×4.5)×(20−2×4.5)=121 μm² to (40+2×4.5)×(20+2×4.5)=841 μm². Meanwhile, with the dimensional accuracy of the light-shielding film 34 made of chromium being 0.5 μm, and the dimensional accuracy of the color material 32 shown in FIG. 10 being 3 μm which is equivalent to those of the first and second preferred embodiments, the area of the color material opening 35 according to the third preferred embodiment varies over a range from (80−2×0.5)×(5−0.5−3)=118.5 μm² to (80+2×0.5)×(5+0.5+3)=688.5 μm².

That is, by changing the color material opening 35 shown in FIG. 5 to the color material opening 35 according to the third preferred embodiment, the variation with reference to the desired area from about +110% to about −69.8% can be improved to from about +72.1% to about −70.4%. FIG. 11 illustrates the area variation of the color material opening 35 shown in FIG. 5, and the area variation of the color material opening 35 shown in FIG. 10 according to the third preferred embodiment.

As described above, in the liquid crystal display device according to the third preferred embodiment, the sum of the length of the side in contact with the color material 32 in the color material opening 35 amounts to 50% or less to the perimeter of the color material opening 35. This improves the area variation of the color material opening 35, thereby reducing variations in optical characteristics of reflected light. It is understood from the results of the second and third preferred embodiments that an optimum color material opening 35 should be such that the sum of the length of the side in contact with the color material 32 in the color material opening 35 is 12.5% or more and 50% or less to the perimeter of the color material opening 35.

### Fourth Preferred Embodiment

A semi-transmissive liquid crystal display device according to a fourth preferred embodiment of this invention has the same structure as the first preferred embodiment, except the color material opening 35 formed over the color filter substrate 30. Thus, the color material opening 35 will be described below and descriptions of the other elements are omitted.

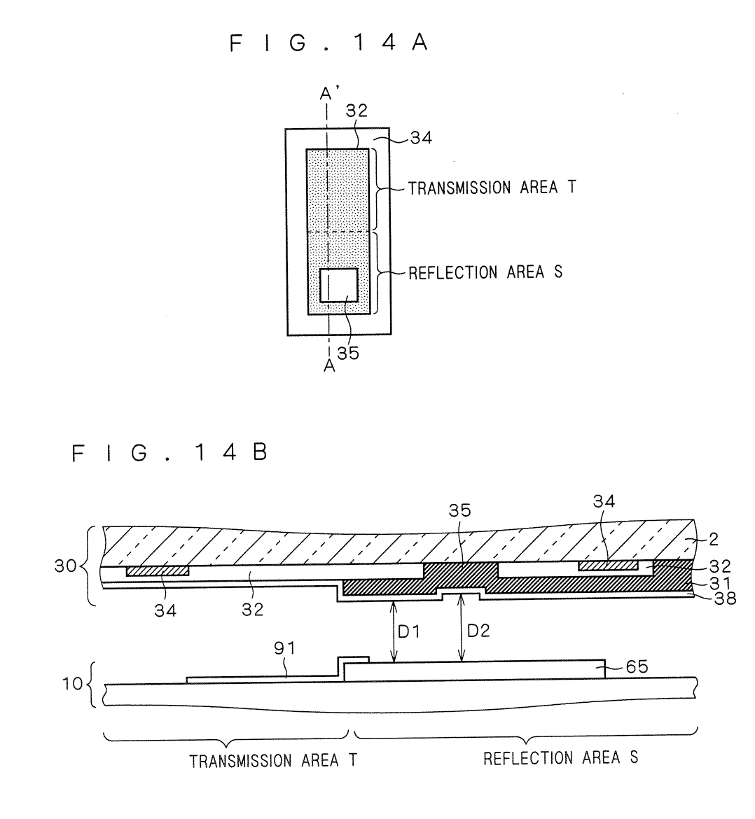

FIG. 12 depicts the structure of a color filter for one picture element in the semi-transmissive liquid crystal display device according to the fourth preferred embodiment. In FIG. 12, the color material 32 is arranged in the order of the red color material 32R, the green color material 32G, and the blue color material 32B from left to right, with the light-shielding film 34 being formed around the color material 32. Each of the color materials 32 is divided into the transmission area T and the reflection area S, and the color material opening 35 is provided in the reflection area S.

As depicted in FIG. 12, in the semi-transmissive liquid crystal display device according to the fourth preferred embodiment, two sides of the color material opening 35 are formed by the light-shielding film 34. Namely, the color material opening 35 having two sides surrounded by the light-shielding film 34 and the remaining two sides surrounded by the color material 32 is formed in the reflection area S. The area of the color material opening 35 is set to attain desired reflectivity. When the color material 32 has a stripe pattern, the color material opening 35 may be formed in such a shape as to separate the stripe, or when the color material 32 has a dot pattern, the color material opening 35 may be formed in such a shape as to cut out part of the dot.

In FIG. 12, a/3 denotes the horizontal length of one pixel, x(x<(a<3)) denotes the horizontal length of the color material opening 35, and y(y<a) denotes the vertical length of the color material opening 35. In this case, the ratio of the sides in contact with the color material 32 to the perimeter of the color material opening 35 is expressed by the equation, (x+y)/(2x+2y)=1/2. In short, the ratio of the sides in contact with the color material 32 to the perimeter of the color material opening 35 is 50%. Stated another way, the color material opening 35 according to the fourth preferred embodiment is formed in such a manner that the sum of the lengths of the sides in contact with the light-shielding film 34 is equal to the sum of the lengths of the sides in contact with the color material 32.

With respect to the color material opening 35 shown in FIG. 5 that is surrounded by the color material 32 in four sides (where A denotes the horizontal length and B the vertical length), the area thereof is determined by (A±double dimensional accuracy of the color material 32)×(B±double dimensional accuracy of the color material 32). On the other hand, the area of the color material opening 35 according to the fourth preferred embodiment is determined by (x±dimensional accuracy of the color material 32±dimensional accuracy of the light-shielding film 34)×(y±dimensional accuracy of the color material 32±dimensional accuracy of the light-shielding film 34). Note that the dimensional accuracy of the color material 32 is lower than that of the light-shielding film 34 which is typically a metal film processed by photolithography. Accordingly, the area of the color material opening 35 according to the fourth preferred embodiment can be finished more accurately than the area of the color material opening 35 shown in FIG. 5.

To give specific examples, when setting a desired area of the color material opening 35 to 1600 μm², the color material opening 35 shown in FIG. 5 has a horizontal length of A=40 μm and a vertical length of B=40 μm, while the color material opening 35 according to the fourth preferred embodiment has a horizontal length of x=40 μm and a vertical length of y=40 μm. The ratio of the sides in contact with the color material 32 to the perimeter of the color material opening 35 according to the fourth preferred embodiment is 50%.

In this case, with the dimensional accuracy of the color material 32 being 3 μm, the area of the color material opening 35 shown in FIG. 5 varies over a range from (40−6)×(40−6)=1156 μm² to (40+6)×(40+6)=2116 μm². Meanwhile, with the dimensional accuracy of the light-shielding film 34 made of chromium being 0.5 μm, the area of the color material opening 35 according to the fourth preferred embodiment varies over a range from (40−0.5−3)×(40−0.5−3)=1332.3 μm² to (40+0.5+3)×(40+0.5+3)=1892.3 μm².

That is, by changing the color material opening 35 shown in FIG. S to the color material opening 35 according to the fourth preferred embodiment, the variation with reference to the desired area from about +32.3% to about −27.8% can be improved to from about +18.3% to about −16.7%. FIG. 13 illustrates the area variation of the color material opening 35 shown in FIG. 5, and the area variation of the color material opening 35 shown in FIG. 12 according to the fourth preferred embodiment.

As described above, the liquid crystal display device according to the fourth preferred embodiment includes the color material opening 35 having at least two sides formed over the light-shielding film 34 of finished dimensional accuracy higher than that of the color material 32. This improves the area variation of the color material opening 35, thereby reducing variations in optical characteristics of reflected light.

### Fifth Preferred Embodiment

A semi-transmissive liquid crystal display device according to a fifth preferred embodiment of this invention has the same structure as the first preferred embodiment, except the color material opening 35 formed over the color filter substrate 30. Thus, the color material opening 35 will be described below and descriptions of the other elements are omitted.

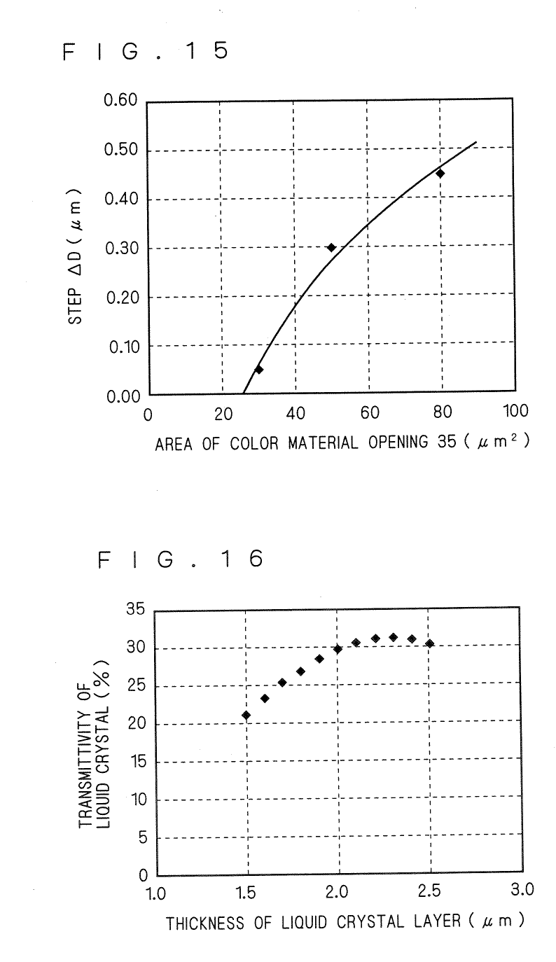

FIG. 14A is a plan view illustrating one pixel of the color filter in the semi-transmissive liquid crystal display device according to the fifth preferred embodiment. In FIG. 14A, the color material 32 is divided into the transmission area T and the reflection area S, and the color material opening 35 is provided in the reflection area S. FIG. 14B is a cross-sectional view taken along the line A-A′ in FIG. 14A that includes the color material opening 35.

In the color filter substrate 30 shown in FIG. 14B, the light-shielding film 34 and the color material 32 are formed on the transparent insulation substrate 2, and the color material opening 35 is provided partially in the color material 32 in the reflection area S. Further in the color filter substrate 30, the transparent resin layer 31 is formed to cover the color material 32 in the reflection area S while burying the color material opening 35. The transparent electrode 38 as an opposed electrode is laminated on the transparent resin layer 31 and the color material 32. For the purpose of indicating the thickness of the liquid crystal layer, the reflection pixel electrode 65 and the transmission pixel electrode 91 on the TFT array substrate 10 side are illustrated in FIG. 14B, where D1 denotes the thickness of the liquid crystal layer in the reflection area S, and D2 the thickness of the liquid crystal layer in the color material opening 35.

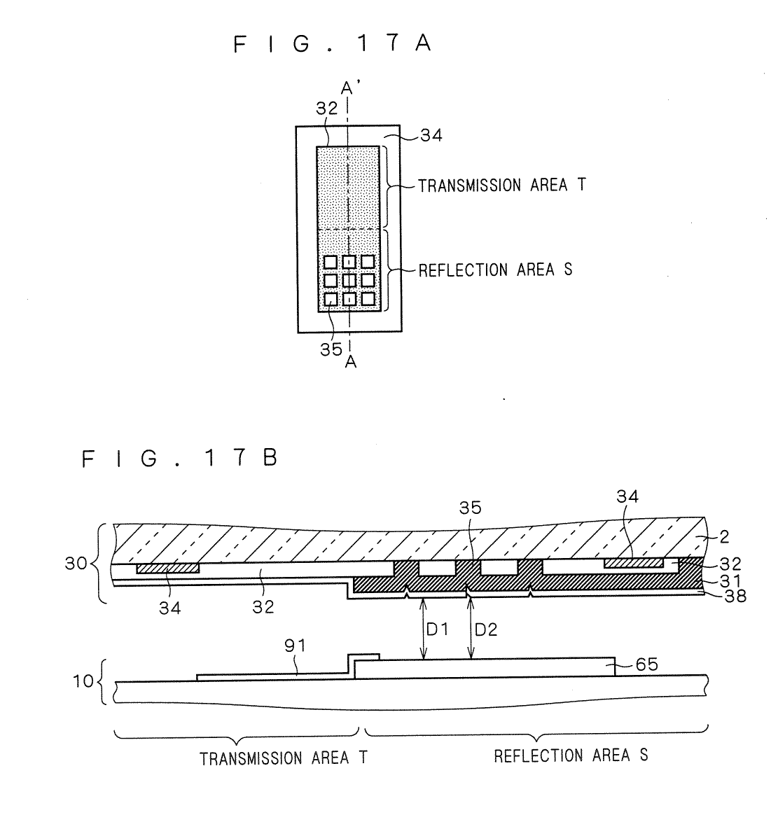

Letting ΔD denote a step between the thickness D1 of the liquid crystal layer in the reflection area S and the thickness D2 of the liquid crystal layer in the color material opening 35, the relationship between the step ΔD and the area of the color material opening 35 is illustrated in FIG. 15. With the thickness of the color material 32 being set to from 1.2 μm to 1.3 μm, FIG. 15 shows that the step ΔD becomes greater than 0 when the area of the color material opening 35 exceeds about 30 μm□ (30 μm×30 μm=900 μm²). It is thus shown that the transparent resin layer 31 on the color material opening 35 becomes uneven when the area of the color material opening 35 becomes greater than about 30 μm□.

In such ways, a change in thickness of the liquid crystal layer in the reflection area S has an influence upon transmittivity. The transmittivity of the liquid crystal changes with the thickness of the liquid crystal layer, as depicted in FIG. 16. For example, the transmittivity is about 21% with the liquid crystal layer thickness being 1.5 μm, and about 30% with the liquid crystal layer thickness being 2.5 μm. Accordingly, the thickness of the liquid crystal layer varies in the reflection area S when the area of the color material opening 35 exceeds about 30 μm□, causing the transmittivity to change in the reflection area S, further causing the reflectivity to vary in the reflection area S.

For this reason, the semi-transmissive liquid crystal display device according to the fifth preferred embodiment includes the color material opening 35 with an area of 30 μm□ or less. However, the area of the color material opening 35 may become 30 μm□ or more as its value is determined in design terms. In such case, an adjustment is made to obtain a desired opening area by providing a plurality of color material openings 35 with an area of 30 μm□ or less.

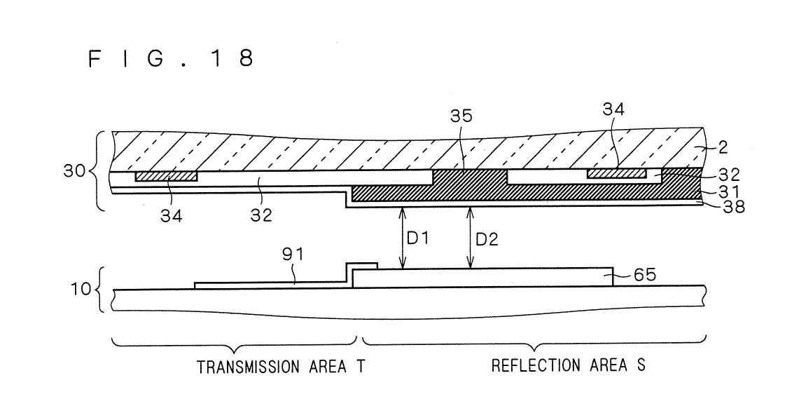

FIG. 17A is a plan view illustrating another one pixel of the color filter in the semi-transmissive liquid crystal display device according to the fifth preferred embodiment. In FIG. 17A, an opening with a desired area is formed by providing nine color material openings 35 with an area of 30 μm□ or less. FIG. 17B is a cross-sectional view taken along the line A-A′ in FIG. 17A that includes the color material openings 35.

FIG. 17B shows that due to the small area of the color material openings 35, the transparent resin layer 31 on the color material openings 35 filled with the transparent resin layer 31 has a planar surface. Namely, in the FIG. 17B case where the difference between the thickness D1 of the liquid crystal layer in the reflection area S and the thickness D2 of the liquid crystal layer in the color material opening 35 is small, the step ΔD becomes 0.1 μm or less. The transmittivity is thus rendered uniform in the reflection area S, thereby reducing variations in reflectivity in the reflection area S.

The area of the color material openings 35 is set to 30 μm□ or less when the color material 32 has a thickness of 1.2 μm to 1.3 μm. When the color material 32 has other thicknesses, the area of the color material openings 35 is limited to a prescribed area or less in such a manner that the step ΔD becomes a prescribed value or less when the color material opening 35 is filled with the transparent resin layer 31.

As described above, the semi-transmissive liquid crystal display device according to the fifth preferred embodiment improves variations in reflectivity in the reflection area S by limiting the area of the color material openings 35 to 30 μm□ or less. Combinations of the semi-transmissive liquid crystal display device according to the fifth preferred embodiment and those of the first to fourth preferred embodiments allow further reductions in variations in optical characteristics of reflected light.

### Sixth Preferred Embodiment

A semi-transmissive liquid crystal display device according to a sixth preferred embodiment of this invention has the same structure as the first preferred embodiment, except the color material opening 35 formed over the color filter substrate 30. Thus, the color material opening 35 will be described below and descriptions of the other elements are omitted.

FIG. 18 is a cross-sectional view illustrating one pixel of the color filter in the semi-transmissive liquid crystal display devices according to the first to fourth preferred embodiments. In the color filter substrate 30 shown in FIG. 18, the light-shielding film 34 and the color material 32 are formed on the transparent insulation substrate 2, and the color material opening 35 is provided partially in the color material 32 in the reflection area S. Further in the color filter substrate 30, the transparent resin layer 31 is formed to cover the color material 32 in the reflection area S while burying the color material opening 35. The transparent electrode 38 as an opposed electrode is laminated on the transparent resin layer 31 and the color material 32. For the purpose of indicating the thickness of the liquid crystal layer, the reflection pixel electrode 65 and the transmission pixel electrode 91 on the TFT array substrate 10 side are illustrated in FIG. 18, where D1 denotes the thickness of the liquid crystal layer in the reflection area S, and D2 the thickness of the liquid crystal layer in the color material opening 35. ΔD denotes a step between the thickness D1 of the liquid crystal layer in the reflection area S and the thickness D2 of the liquid crystal layer in the color material opening 35.

In the sixth preferred embodiment, the transparent resin layer 31 is polished, either chemically or physically, before laminating the transparent electrode 38 thereon, to thereby remove the step ΔD. Thus, the thickness D1 of the liquid crystal layer in the reflection area S and the thickness D2 of the liquid crystal layer in the color material opening 35 are rendered uniform. This makes the transmittivity uniform and reduces variations in reflectivity in the reflection area S.

As described above, the semi-transmissive liquid crystal display device according to the sixth preferred embodiment chemically or physically polishes the transparent resin layer 31. This improves variations in reflectivity in the reflection area S, allowing further reductions in variations in optical characteristics of reflected light.

A combination of the chemical or physical polishing of the transparent resin layer 31 according to the sixth preferred embodiment and the semi-transmissive liquid crystal display device according to the fifth preferred embodiment where the color material opening 35 has a limited area allows removal of the step of about 0.1 μm present on the transparent resin layer 31. This further improves variations in reflectivity in the reflection area S.

While the invention has been shown and described in detail, the foregoing description is in all aspects illustrative and not restrictive. It is therefore understood that numerous modifications and variations can be devised without departing from the scope of the invention.

What is claimed is:

1. A semi-transmissive liquid crystal display device comprising:
a first substrate including a transmission pixel electrode that forms a transmission area, and a reflection pixel electrode that forms a reflection area;
a second substrate including a color filter formed by using a color material, and a light-shielding film provided around said color filter; and
a liquid crystal held between said first substrate and said second substrate,
said semi-transmissive liquid crystal display device further comprising:
an opening provided in said color material in said reflection area, said opening having at least two sides formed over said light-shielding film of finished dimensional accuracy higher than that of said color material; and
a resin film formed to cover said color material while burying said opening.

2. A semi-transmissive liquid crystal display device comprising:
a first substrate including a transmission pixel electrode that forms a transmission area, and a reflection pixel electrode that forms a reflection area;
a second substrate including a color filter formed by using a color material, and a light-shielding film provided around said color filter; and
a liquid crystal held between said first substrate and said second substrate,
said semi-transmissive liquid crystal display device further comprising:
an opening provided in said color material in said reflection area, wherein the sum of a length of a side of said opening in contact with said light-shielding film is longer than the sum of a length of a side of said opening in contact with said color material; and
a resin film formed to cover said color material while burying said opening.

3. The semi-transmissive liquid crystal display device according to claim 2, wherein the sum of a length of a side in contact with said color material in said opening is 12.5% or more and 50% or less to the perimeter of said opening.

4. The semi-transmissive liquid crystal display device according to claim 1, wherein the area of said opening is limited to 30 μm□ (30 μm×30 μm=900 μm²) or less when said color material has a thickness of from 1.2 μm to 1.3 μm.

5. The semi-transmissive liquid crystal display device according to claim 2, wherein the area of said opening is limited to 30 μm□ (30 μm×30 μm=900 μm²) or less when said color material has a thickness of from 1.2 μm to 1.3 μm.

6. A method of manufacturing a semi-transmissive liquid crystal display device, said semi-transmissive liquid crystal display device comprising:
a first substrate including a transmission pixel electrode that forms a transmission area, and a reflection pixel electrode that forms a reflection area;
a second substrate including a color filter formed by using a color material, and a light-shielding film provided around said color filter;
a liquid crystal held between said first substrate and said second substrate;
an opening provided in said color material in said reflection area, said opening having at least two sides formed over said light-shielding film of finished dimensional accuracy higher than that of said color material; and
a resin film formed to cover said color material while burying said opening,
said method including chemical or physical polishing of said resin film.

7. A method of manufacturing a semi-transmissive liquid crystal display device, said semi-transmissive liquid crystal display device comprising:
a first substrate including a transmission pixel electrode that forms a transmission area, and a reflection pixel electrode that forms a reflection area;
a second substrate including a color filter formed by using a color material, and a light-shielding film provided around said color filter;
a liquid crystal held between said first substrate and said second substrate;
an opening provided in said color material in said reflection area, wherein the sum of a length of a side of said opening in contact with said light-shielding film is longer than the sum of a length of a side of said opening in contact with said color material; and
a resin film formed to cover said color material while burying said opening,
said method including chemical or physical polishing of said resin film.

8. A semi-transmissive liquid crystal display device comprising:
a first substrate including a transmission pixel electrode that forms a transmission area, and a reflection pixel electrode that forms a reflection area;
a second substrate including a color filter formed by using a color material, and a light-shielding film provided around said color filter; and
a liquid crystal held between said first substrate and said second substrate,
said semi-transmissive liquid crystal display device further comprising:
an opening provided in said color material in said reflection area; and
a resin film formed to cover said color material while burying said opening, wherein
the area of said opening is limited to 30 μm□ (30 μm×30 μm=900 μm²) or less when said color material has a thickness of from 1.2 μm to 1.3 μm.
